(19) United States
(12) Patent Application Publication
(10) Pub. No.: US 2004/0059644 A1
(43) Pub. Date: Mar. 25, 2004

(54) System and method for digital item exchange

(76) Inventor: Abraham Blau, Tel Aviv (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 10/664,853

(22) Filed: Sep. 22, 2003

Related U.S. Application Data
(63) Continuation-in-part of application No. PCT/IL02/00216, filed on Mar. 19, 2002.
(60) Provisional application No. 60/277,064, filed on Mar. 20, 2001.

(51) Int. Cl. G06F 17/60

(52) U.S. Cl. 705/26

(57) ABSTRACT

A system and a method to exchange digital items among peers of computer networks. The items may comprise, without limitation, files, CP, BW, storing space, money, licenses, contracts, information and any other shareable resource of peers on a computer networks. The system and method may offer the item, bid, transfer and pay for the item. A buyer of the item may become a potential seller of it. The creator of the item may receive a percentage of the payment for any transfer of the item.

### CROSS-REFERENCE TO RELATED APPLICATIONS

This application is a continuation-in-part of PCT Patent Application PCT/IL02/00216, international filing date Mar. 19, 2002, which claims priority from U.S. Provisional Patent Application 60/277,064, filed Mar. 20, 2001.

### FIELD OF THE INVENTION

The present invention relates generally to systems and methods for the search, find, arrange, request, offer, transfer, share and exchange of digital items, such as but not limited to, digital content, files, certificates, licenses, money, options, contracts, computing-power, storing-space and bandwidth.

### BACKGROUND OF THE INVENTION

Most computer networks today are centralized. In these networks, a central server controls and involves in most of the applications. This server can be very busy, it can be very expensive, it might require high-level professionals to operate it and it can become a bottleneck and the weakest link of the network.

However, there are networks in which the workload is distributed between the network peers. These networks are usually called peer-to-peer (P2P) networks. On such networks, there might or might not be a central server but the functions of the server are limited and most of the load is distributed among the peers.

Three major resources of the network peers are better utilized on P2P networks: The communication line bandwidth (BW), the computing power (CP) and the storing capacity. P2P File sharing applications on the Internet are good examples for the utilization of unused BW of the network peers. Internet application like “seti@home” is a good example for the utilization of unused CP of the network peers.

P2P File sharing applications are very popular. Several millions copies of such applications are downloaded to Internet users computers every week. These applications stand first, for several years now, in the list of most downloaded applications on the Internet.

The Most popular file-sharing applications are free. Using these applications, the users can transfer files among them without paying anyone. As a result, two main problems arise: copyrights problem and QoS (quality of service) problem.

The copyright problem arise, since many of the transferred files in the file sharing systems, are copyrighted. The most popular transferred files are songs, movies, pictures, articles and applications. The users do not pay for the transferred copyrighted files and the copyright owners sue the file sharing service operators, the ISP (internet service provider) of the users and the users themselves, in order to shut down the free file sharing networks. In a few cases, they succeeded, in others they failed. Anyway, P2P file sharing network continue to proliferate.

The second problem of file sharing is a QoS (quality of service) problem, since most of the users want to get files, but do not want to give files to others. It is also called the “free riding” problem.

There are many attempts to solve the copyright problem by using encryption and by using watermarks (hidden information in the file). These methods give the copyright owners control over how and when the user can use the copyrighted file. For example, some systems may encrypt the content item, mark the content item with a unique watermark and mark the player program on the users' computer with a unique mark. Upon payment of a fee, the user may play the content item for a limited number of times, or for a limited period of time and the like. However, such systems are usually complicated, not user-friendly and may be broken by hackers. Until now, these methods do not have significant acceptance and use.

### SUMMARY OF THE INVENTION

The present invention seeks to provide its user with the best way to manage their digital resources, their digital items and their rights on these items, by means of a system and a method for the transfer and exchange of items, such as but not limited to, digital content, files, certificates, licenses, money, options, contracts, CP, communication line BW, and/or HD (hard disk) space. The present invention may provide different tools and features in this regard, such as but not limited to: Optimization of the network peers resources utilization, maximization of the rewards to the user from their digital items and from their computer resources, transfer of micropayments between users, royalty payments to copyright holders, presentation and offers of licenses and ratings of the users' performance, users' actions and users' authentication level in the system. The invention, unlike the prior art, offers a solution to the copyright problem that can work even without DRM and it offers a solution to the QoS problem by providing incentives and motivation to offer and sell items.

The present invention may enable management of digital items over computerized networks or on a single computer. The invention may enable users to search for digital items, to express offers or requests for digital items, and to exchange digital items that are transferable over such networks. The invention may enable optimization of the use of BW in computer networks. The system of the invention preferably promotes and gives priority to high BW peers on the network. In this manner, the items are distributed faster, the load on the network is more homogeneous and BW bottlenecks may be reduced or prevented. The invention may eliminate the need for expensive servers and trained personnel to manage them.

In one embodiment of the present invention, a digital item is offered for sale. A buyer who purchases the digital item then becomes authorized to sell it to further buyers. The capability to sell the digital item is a function of the upload capability of the seller and of a download capability of the buyer. For example, a user with a large download communications bandwidth (BW) may download from several users who possess small upload BW. Conversely, a user with a large upload BW may upload to several users who possess small download BW.

When a popular item is new in the system, usually a few users have it and many users want it. In addition, many users have asymmetric communication lines with download BW higher than the upload BW. In another addition, some of the users do not offer the item for sell after they bought it. The result is that usually, the total download BW of the buyers is greater than the total upload BW of the sellers, so there is typically a queue of buyers who are waiting for their turn to download. In contrast to the waiting buyers, sellers usually do not wait. They are busy uploading items. When a seller finish transferring an item, he has some free upload BW and he start immediately to transfer its most expensive item. The transfers of a certain item stop when there is no requests or no offers of the particular item. The transfer of the digital item may typically be started with the requesters with the highest bids. If the sender has a free upload bandwidth smaller than the free download bandwidth of the receiver, the first offerer to have free BW (or several first offerers, if one don't have enough free BW) may be chosen (randomly or not) to join the transfer to the highest bidder. If, after giving the highest bidder all the bandwidth the highest bidder may use, the seller still has available upload bandwidth, the remaining bandwidth may be used immediately with the next highest bidder. Accordingly, a large download BW may enable the user to download faster and to quickly start uploading (selling) the item, before the price drops too much. A large upload BW may enable the user to upload faster and sell the item more times before the price of the item drops.

The transfer of items between sellers and buyers may be carried out by dividing the users with a minimum amount of free BW, into a list of buyers (L1) and a list of sellers (L2). List L1 of buyers may be sorted by the bid price (highest bid at the top of the list) and by the time of the bid (for the same price, earliest bid appear first on the list). List L2 of sellers may be sorted by the asked price (lowest offer first) and by the time of the offer (earlier time first).

A pair comprising a buyer and a seller may be selected from the top of the two lists L1 and L2. If the bid price is less than the asked price or at least one of the lists is empty, then the system may go into a waiting mode until new entries are entered into the lists. If a pair has been chosen and the prices are suitable for a transaction, then the system may commence transfer of the item between the buyer and the seller with the maximum possible bandwidth. Afterwards, the system may rearrange the lists and checks them again to pick the next pair of buyer and seller.

In addition to, or instead of, sorting L1 and/or L2 by price and/or precedence, it is also possible to sort L1 and/or L2 according to the proximity of the users in the pairs, according to minimum nodes in the route between the users, or according to any other optimization criteria.

One example of proximity between users may be geographic proximity in the physical world. For example, if two users are connected to the system through a common Internet service provider (ISP), a fact that can be determined from their IP addresses, those two users may be preferred as a potential pair as opposed to other users who are connected through different ISPs, or who are in different countries. This way of preferring pairs may make the overall system more efficient in terms of utilization of network resources.

If the content is copyrighted, then the system of the invention ensures that a royalty is paid to the copyright owner for each transfer of the content, so the copyright owner has an incentive to allow as many transfers as possible. The incentive of the copyright owner is to beat the free systems. If his/her item is transferred in free systems, he/she gets nothing. If the copyright owner insists on too high royalties, users may try to obtain the item in a free system and the copyright owner would miss an opportunity to be rewarded.

The royalty percentage (from the sell price), royalty minimum and royalty maximum, may be determined by the copyright owner. A default, maximum royalty percentage and royalty minimum, may be fixed for items if the identity of the creator of the license of the item, is not sufficiently verified. The better the verification, authentication, rating and money balance of the user, the easier it is for him/her to create lower-than-the-maximum-percentage-royalties licenses and retrieve royalty money from the system, after the royalty money has been collected. As another example, the system may permit creation of licenses only by users, who pass a certain level of verification and authentication, and/or users who deposit a certain amount of money in custody and/or users who have a minimum rating on the system. As yet another example, the system may permit transaction for items only it the items has a license that was created by such authorized and recognized users. The system may present the user's rating and level of authentication to other users. In such a case, users may choose to carry out transactions only with users who have a minimum rating or a minimum level of authentication.

The present invention may integrate various features, such as but not limited to, peer-to-peer requesting, offering, exchanging, sharing, connections and transfers, a search engine, a micropayments system, a trading system, copyright management, royalties payment, rating of users and items, and management and controlled reproduction of items (e.g., licenses, certificates, contracts, or collectible cards, for example).

An item stored in the system may have keywords (KWs) attached thereto. In the present invention, KWs may be arranged in a Boolean expression to facilitate searching. KWs may be typed manually or may be selected from lists. For example, a first KW may be selected from a list of all the existing KWs. A second KW if needed, may be selected from a list of KWs, which together with the first KW gives a non-empty list of items. Additional KWs may be selected in a similar recursive way. Previously selected KW may be unselected, or replaced by other KWs from the list. The selection of KWs is done in such a way that there is always a non-empty list of items, which relates to the KWs. Typing one or more first letters of a KW may cause the system to display all KWs that start with those letters. The lists of KWs may display, beside each unselected KW, a number indicating how many items would be selected if this certain KW were to replace the selected KW.

The present invention may enable management of royalty payments: Items in the system may be marked as being copyrighted by the copyright owners. Such marked items may be transferred in the system with a license. The license itself may be an item in the system. The license may carry information, such as but not limited to, the names of the copyright owners and what percentage of the price of the marked item should be transferred to the each one of the copyright owners. When searching for items to purchase, prospective buyers may readily see if the sought-after item is marked or not.

For example, items may be marked as being licensed for distribution. Prospective buyers may readily see with what kind of license the sought-after item is marked, and the rating of the user who is providing the item. A minimum and/or maximum price for the item may also be part of the license, together with conditional parameters, such as but not limited to, time dependencies, number of copies of the item, and the like. The owner of the license may be permitted to change the parameters on the license manually, even after the Item has started to be transferred, if certain guide rules are followed. For example, it might not be allowed to make the percentage or the minimum royalties higher, after some users make offers of requests for the Item.

A user of the system of the present invention may have a personal account in which funds may be held. Payment between two users may be transacted by subtracting the required amount from one account and adding it to another account. The payment system may support transactions with delayed payments or transactions with conditional payments. For example, while the payment is delayed or conditioned, the payment may be kept in custody by the system. The two sides of the transaction may agree in advance when the money is released and what happens if they do not agree. In case of a conflict, they may choose an arbitrator, such as from a list of very reliable users, which the system may provide. As another example, the user ratings may include the number of times the user had disagreements with other users. Users may choose to avoid transactions with anyone whose rating is under certain level, or may choose to do transactions only if they may cancel the payment without questions. The number of cancellations may also be part of the user rating.

Some embodiments of the invention are summarized here, but it is emphasized that the invention is not limited to this summary:

There are provided in accordance with an embodiment of the invention a system and a method for searching including items (including digital items), a list of items certain details, such as items names (hereinafter: L1), keywords, a list of keywords (hereinafter: LKW), each item connected to at least one keyword, a computer system to store the items, if the items are storable, like files, a computer system to store all the lists and all the connections between items and keywords, and a computer software to select a keyword from the LKW, create a new LKW, or erase an unneeded LKW.

In accordance with an embodiment of the invention, the method for searching may include:

displaying one or more LKWs, wherein each keyword in every LKW can be selected or unselected, and

displaying, next to each keyword in every LKW, the number-of-items-that-would-be-found if this keyword were selected,

wherein there is an “or” Boolean operator between groups of items selected by keywords from the same LKW and

wherein there is an “and” Boolean operator between groups of items selected by keywords from different LKW.

In accordance with an embodiment of the invention, in addition to the number-of-items-that-would-be-found, it is possible to display at least one of: how much times that keyword was selected by others, the number of items that keyword is connected to, the rating of that keyword, the maximum/minimum/average price of the items that would be found if that keyword were selected, and any other information, stored in the system, on that keyword, or on the items that would be found if that keyword were selected. The Boolean operators can be any other Boolean operators and the Boolean operators can be operated on any group of the items.

Further in accordance with an embodiment of the invention if there is a selected keyword in every LKW, a new LKW is created with no selected keywords, and if there are two or more LKWs with no selected keyword, one of them remains and the rest are removed.

There are also provided in accordance with an embodiment of the invention a system and a method for the exchange of digital items, including a network of computers, each computer connected to the network has at least one of upload bandwidth capacity and download bandwidth capacity, wherein the computers may do at least one of send, receive and share among them digital items, wherein the digital items may include at least one of: files, licenses for holding, transferring, requesting, offering, buying, selling and using files, a license to be in a negative balance, a certificate of high reliability, a certificate of authenticity, a certificate of verified personal details, a collectible card with the user picture, a license to send money to other users, a license to receive money from other users, various rights including the right to get and give royalties, messages, certificates, contracts, options, resources including bandwidth of communication line, computing power and storing space, digital money, digital items that can be registered digitally, digital items that can be transferred over computer network, wherein the system may manage personal accounts for the computers and for its users and wherein these accounts may store money and wherein the operations that may be done with these accounts are at least one of: transfer money from one account to another account, deposit money in the account, withdraw money from the account, wherein the computers may, under certain conditions, be offerers and generate offers to send items, wherein the computers may, under certain conditions, be requesters and generate requests to receive items, wherein the computers may, under certain conditions, accept offers of other computers, wherein the computers may, under certain conditions, accept requests of other computers, and wherein the computers may search, find, and arrange, at least one of: lists of items, lists of offers to send items, lists of requests to receive items, details about the items, details about the computers, details about the bandwidth, details about the users, details about the offers, details about the requests.

In accordance with an embodiment of the invention, the offer to send an item may include a minimum ask price, the request to receive item may include a maximum bid price, the price may be an amount of other item, another item may be electronic money and wherein a transaction may be an exchange of the item for an amount of other item.

In accordance with an embodiment of the invention every request and every offer may include at least one of creation time, registration time, the time at which the requester got some available free download bandwidth, the time at which the offerer got some available free upload bandwidth, the period of time for which the offer is active and the period of time for which the request is active.

In accordance with an embodiment of the invention the time can be measured by at least one of a central watch, and the distributed computers watches, with time adjustments, wherein the adjustments may be based on ping times.

In accordance with an embodiment of the invention if there are several active bids, higher active bids will have priority over lower active bids and if there are bids with equal prices, older bids will have priority over younger bids, and if there are several active asks, lower active asks will have priority over higher active asks and if there are asks with equal prices, older asks will have priority over younger asks.

In accordance with an embodiment of the invention if matching offers and requests are found with bid prices that are higher than or equal to ask prices, then the oldest offer will be matched with the oldest request and the price of the transaction will be the price of the oldest between these two.

In accordance with an embodiment of the invention a transfer of the digital item can start only if the sender has free upload bandwidth above a certain limit and the receiver has free download bandwidth above a certain limit, wherein these two limits may or may not be equal, wherein each one of these limits may be applicable only to digital items above certain capacity, including files above certain size and including computing capacity above certain level and wherein each one of these limits may not be applicable to digital items below certain capacity, including items like licenses, contracts and other items that are not necessarily contained in files.

In accordance with an embodiment of the invention a royalty as a part of the price paid for an item can be taken and divided among one or more users who are entitled to get this royalty, wherein the royalty may be a function of the price, such as a percentage, or a fixed value, or any other function, wherein the royalty may have minimum and maximum values, wherein the royalty, the maximums and the minimums, may be determined by certain users.

In accordance with an embodiment of the invention a commission, as a part of the price paid for an item, can be taken and divided among one or more users who are entitled to get this commission, wherein the commission may be a function of the price, such as a percentage, or a fixed value, or any other function, and wherein the commission may be predefined or otherwise be determined by certain users.

In accordance with an embodiment of the invention a sale of the digital item by the senders to the receiver, is transactable only if a condition is met, the condition including at least one of a minimum selling price, a maximum selling price, a minimum number of requesters, a maximum number of requesters, a minimum number of offerers, a maximum number of offerers, a minimum level of rating of a user, a maximum level of rating of a user, the existence of an item in the possession of a user, the lake of existence of an item in the possession of a user, a minimum amount of money in the user's account, a maximum amount of money in the users' account.

In accordance with an embodiment of the invention the level of rating is a function of an information on the user, wherein the information on the user can include at least one of number of sold items, number of bought items, total amount of money spent on buying items, total amount of money gained from sold items, total amount of money from royalties, number of disconnections in the middle of a transfer, number of cancellations of a payment, number of complains of other users, number of complains on other users, rating of the complaining users, level of verification of the user identity, seniority in the system, period of time in the system, maximum upload bandwidth, average upload bandwidth, maximum download bandwidth, and average download bandwidth.

In accordance with an embodiment of the invention the method/system further includes automatically and repeatedly waiting for the computer to have more than a certain minimum of free upload bandwidth, selecting from the items that exist on that computer, the item that have the highest bids, offering it for upload to the highest bidder, sending it and collecting the payment for it.

In accordance with an embodiment of the invention the method/system further includes automatically and repeatedly searching for new items to buy, selecting the right time and price to buy them, entering new requests for them, downloading them at the right time and paying for them.

In accordance with an embodiment of the invention the method/system further includes buying an item and then immediately selling it several times, wherein the buying price and the number of sales of the item are selected such that the average profit for time unit is maximal.

In accordance with an embodiment of the invention the average profit is the difference between the sum of the sales prices and the buying price, divided by the total time invested in downloading and uploading the item.

In accordance with an embodiment of the invention the buying price and the number of sales are a function of at least one of upload bandwidth, download bandwidth, the length of the item, and the behavior of the item's price as a function of time,

and wherein one possible criterion for selecting the time to buy a new item is: if the revenue from selling the item one more time multiplied by the number of times the item was sold is less or equal the revenues from all the sales of the item minus the expense when buying the item, then it is time to buy a new item.

In accordance with an embodiment of the invention the method/system further includes at least one user who can be defined as the user who can change the license of the digital item, wherein the license may dictate who are the users who get royalties for the transfers of the digital item and how much royalties each one of them gets.

In accordance with an embodiment of the invention details about the item, such as its name and its size, can be entered into the system without entering the item itself into the system and wherein item's details can be found in the system when performing a search for items, and wherein an item can be entered into the system later and attached to its existing details, and wherein requests for the item may be placed even when the item itself is not present in the system.

In accordance with an embodiment of the invention, any item might or might not be transferable and any item might or might not be duplicable.

In accordance with an embodiment of the invention there might be one or more special users who have special abilities, wherein these special abilities may include the ability to have negative balance in the money account, wherein there might be licenses which give its holder one or more of this special abilities, wherein there might be a license to give a license for a special ability, wherein these licenses and other licenses might be dependent on at least one of time, the rating of the holding user, the amount of money the user have, or any other characteristic, stored in the system of the holding user, wherein there might be licenses which can be given only by one or more special users.

In accordance with an embodiment of the invention, the method/system further includes three special abilities of users:

to define a new item kind, to change an existing item characteristics and to create a new item of a kind which is already defined in the system, wherein defining a new kind of item, or changing item characteristics might be restricted to one special user or some special users.

In accordance with an embodiment of the invention some users or any user can be the creators of a license and some users or any user can be the license owner (hereinafter LO), wherein the license creator and the LO might or might not be the same user, wherein the LO may be able to transfer the ownership of the license to another user, wherein the LO may be the only user who can view or change the license, wherein the LO may be able to entitle other users and himself, to receive part of the price paid for the item, wherein this part can be a percentage of the price, with possible upper and lower limits and wherein the license might include dynamic information, such as the number of users having the license, the number of users having the file if the license is related to a file, the amount of users who request the file, the amount of royalties collected, or the number of active transactions.

In accordance with an embodiment of the invention the method/system further includes the ability to mark user details as authenticated, the ability to mark user as the copyright owner of an item, the ability to mark user as having the right to get royalties for an item and the ability of some users to grant these marks to users.

In accordance with an embodiment of the invention users with unproven rights to get royalties for an item, might not be able to do at least one of creating a license for the item, defining less than a certain maximum percentage royalties to be paid from any payment for the item, defining less than a certain minimum fixed amount of royalties to be paid from any payment for the item, transferring the royalties to another user in the system, and/or withdrawal of the royalties from their account in the system.

In accordance with an embodiment of the invention the method/system further includes large items that can be divided into smaller parts, wherein each part can be transferred separately and independently, wherein each part can have its own license, wherein the parts can be identified as parts of a large item and wherein there might be a minimum size for the parts.

In accordance with an embodiment of the invention the method/system further includes the ability to uniquely identify items in the system, wherein the identification can be done by using at least one of checksum, digital watermarks, digital signature and any other known identification method.

In accordance with an embodiment of the invention the method/system further includes the ability to transfer a file without its license, if the receiving user already have a license for that file, wherein in this case the user might pay for bandwidth and might not have to pay royalties if there are royalties for that file and the ability to transfer a license for a file without the file itself, wherein in this case the user might pay only royalties and might not pay for bandwidth.

In accordance with an embodiment of the invention the method/system further includes the ability to exchange among the users future contracts and rights for at least one of transferring money in the future, transferring a file in the future, transferring any other item in the future, wherein the system can manage the needed margins for these contracts and rights, wherein the margins can be at least one of the needed amount of money taken from the user's account and kept in custody, and/or preventing the user from having less than the needed amount of money in his account.

In accordance with an embodiment of the invention the method/system includes apparatus for auctioning a digital item for sale from an offerer of the digital item who is authorized to sell the digital item, and apparatus for selling the digital item by uploading to a requester who, upon purchasing and downloading the digital item, is authorized to become another offerer of the digital item, wherein a capability of the offerers to transfer and sell the digital item to further requesters is a function of at least one of a download capability and an upload capability of the offerers.

In accordance with an embodiment of the invention a sale of the digital item by one of the offerers is transactable only if a condition is met, the condition including at least one of:

the offerer has a minimum upload communication bandwidth,

the requester has a minimum download communication bandwidth,

a minimum bid price,

a minimum number of requesters,

a minimum number of offerers, and

a minimum level of rating of the offerer and the requester, wherein the level of rating is a function of a behavior of a user with other users.

In accordance with an embodiment of the invention the method/system includes apparatus for providing searchable items, keywords, a list of keywords (hereinafter: LKW), each item connected to at least one keyword, apparatus for displaying one or more LKWs, wherein each keyword in every LKW can be selected or unselected, and for displaying, next to each keyword in every LKW, the number-of-items-that-would-be-found if this keyword were selected, wherein there is a first group of Boolean operators between groups of items selected by keywords from the same LKW and wherein there is a second group of Boolean operators between groups of items selected by keywords from different LKW.

In accordance with an embodiment of the invention all the Boolean operators in the first group are an “or” and all the Boolean operators in the second group are an “and”.

### BRIEF DESCRIPTION OF THE DRAWINGS

The present invention will be understood and appreciated more fully from the following detailed description taken in conjunction with the drawings in which:

FIG. 1 is a simplified flow chart of a method for digital item exchange.

FIG. 2 is a simplified flow chart of a method for multiple digital items exchange.

FIG. 3 is a simplified illustration of some of the system physical components.

FIG. 4 is a simplified illustration of some of the system operational components.

FIG. 5 is a simplified illustration of a possible way an item and the payment for it, are flowing among users in the system.

### DETAILED DESCRIPTION OF EMBODIMENTS

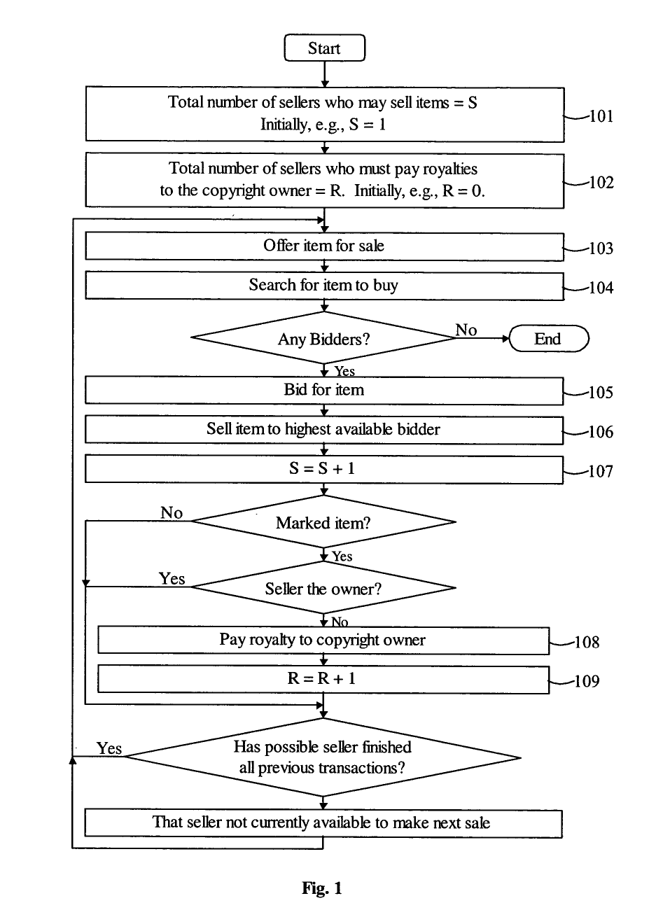

Reference is now made to FIG. 1, which illustrates a method for exchange of items in accordance with a preferred embodiment of the present invention.

The total number of sellers who may sell the item is represented as S. Initially, S may equal one, as in the case that the item is originally offered for sale by the copyright owner (step 101). The total number of sellers who must pay royalties to the copyright owner is represented as R. Initially, R may equal zero, such as before any non-copyright owner purchasing the item (step 102). An item marked as copyrighted is also referred to as a marked item. It may be noted that, in general, R equals S minus the number of copyright owners of the item. Alternatively, everyone, including the copyright owners, may pay royalties when selling the item.

The item is then offered for sale (step 103). The offer for sale may have conditions, such as but not limited to, a minimum selling price, a minimum number of bidders (e.g., if there are less than ten bidders, no offer for sale is made), or a minimum level of rating for the bidders. Users may search for items to buy, such as with a searching method described herein below (step 104). If there are bidders, they bid for the item (step 105). If there are no bidders, then the offer maker may wait until there are bids and then continue to step 105. (While the offer maker waits, the offer may remain active and the item may be found in searches.) The item provider may sell the item by uploading to the highest available bidder (step 106). In other words, the digital item is offered for sale from a first provider (e.g., the copyright owner) of the item (who is authorized to sell the item), and the item is sold to a buyer who, upon purchasing and downloading the item, is authorized to become a second provider of the item. Accordingly, after the sale, the total number of sellers who may sell the item S=S+1 (step 107).

If the item is marked, and the seller is not the copyright owner, then a royalty is paid to the copyright owner (step 108) and the total number of potential sellers who must pay royalties to the copyright owner R=R+1 (step 109).

The item may then further be offered for sale and the process continues until no more bids are made for the item.

In order to sell the item, an item provider needs a minimum amount of free upload BW. In addition, he needs to satisfy certain demands (such as sufficiently high rating). This is explained further in detail herein below with reference to Tables 1.1-1.4.

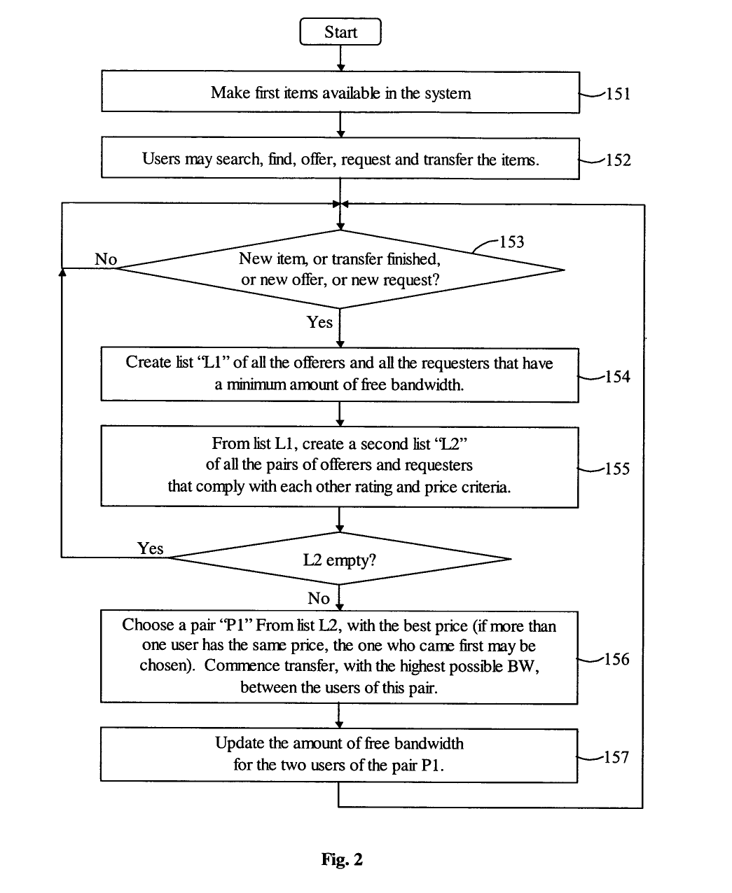

Reference is now made to FIG. 2, which illustrates a more general method for multiple items exchange in accordance with another preferred embodiment of the present invention. Copyrights owners may make items available in the system of the invention (step 151). Other users may search, find, and make offers or requests for the items (step 152). If there is a new item in the system, or a transfer of an item in the system was finished, or a new request for an item was entered, or a new offer of an item was entered (step 153), then the system may use the following procedure: First, a list L1 may be created of all the offerers and all the requesters that have a minimum amount of free BW (step 154). From the list L1, a second list L2 may be created of all the pairs of offerers and requesters that comply with each other rating and price criteria (step 155). If L2 is not empty, then a pair “P1” may be chosen from list L2 with the best price (highest for the requesters and lowest for the offerers). If more than one user has the same price, then the earliest one may be chosen. The transfer may then commence with the highest possible BW between the users of this pair (step 156). Finally, the amount of free BW for the two users of the pair P1 may be updated accordingly (step 157).

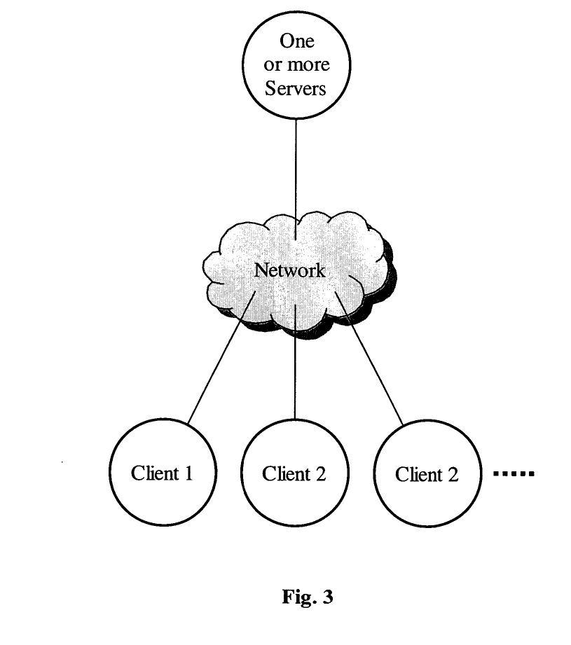

Reference is now made to FIG. 3, which illustrates a possible structure of the physical components of the system. The main parts of the system in FIG. 3 are the clients and the network. There might be an unlimited amount of client and they are connected through a network. The network can be the Internet, it can be a local area network, or any other kind of network. The servers are optional. The clients can do the server work. There is a direct connection among the clients, they can transfer file among them and share computing resources.

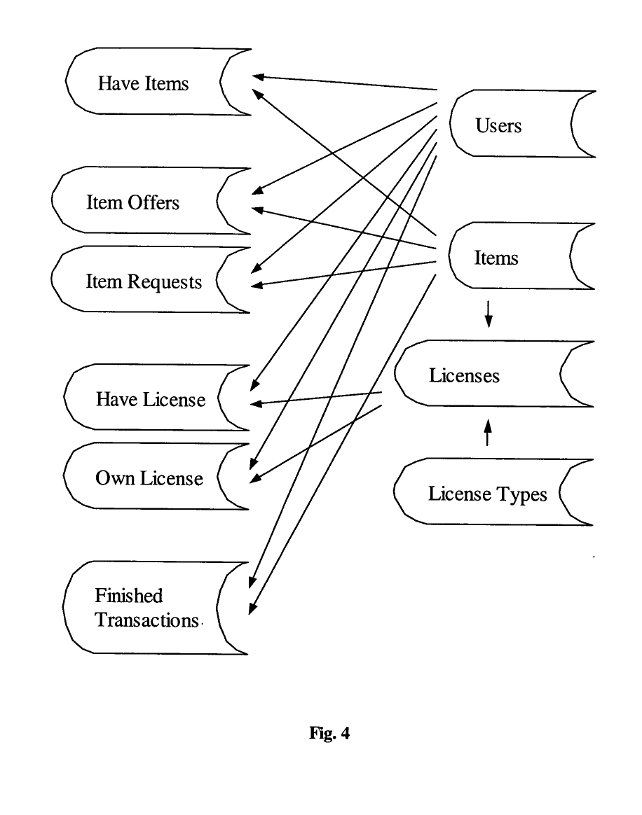

Reference is now made to FIG. 4, which provide an illustrative view of some of the internal components of a preferred embodiment of the system of the invention. It can be seen that there are several basic tables like “Users”, “Items”, and “License Types”. The table “Licenses” can be created by using entries from the “Items” and the “License Types”. The “Have Items” table store all the connection between the “Users” and the “Items” table, hence it show which users own what items in the system. The “Item offers” and “Items Requests” show the list of the offers and the requests in the system. “Have license” table shows who have a license in the system and “Own License” shows who have the right to change the license parameters. The “Finished Transactions” table is a list of all the finished transactions in the system. A transaction is recorded in this table after the transfer of the file was finished and the payment was transferred too.

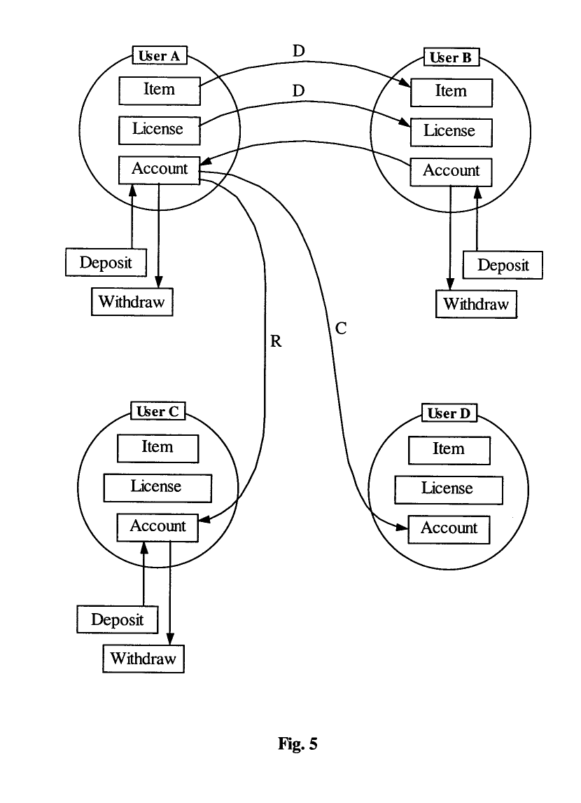

Reference is now made to FIG. 5, which illustrate a possible flow of digital items among the users. Each user in the figure is represented by a circle. User A and user B are demonstrating a transfer of an item (which can be a file). The mark D above the line connecting the item in user A and user B, is a sign that the transferred item is duplicated. The license of the item is also duplicated from user A to user B. The price of the item is moving from the account of user B to the account of user A. The price is of course not duplicated when it is transferred. User C is representing the copyright owner of the item and user D is the operator of the system. If there are royalties to be paid, it is represented by the transfer of money from the account of user A to the account of user C (marked by the letter R). If there are commissions to pay to the operator of the system, it is represented by the transfer of money from the account of user A to the account of user D. The royalties and the commission can be a percentage of the price of the item. The users can deposit funds into their accounts and they can withdraw funds as illustrated.

Reference is now made to Tables 1.1-1.4, which provide an illustrative example of methods of the invention. The example shown in Tables 1.1-1.4 is only for purposes of explaining one example of the invention, but it is emphasized that the present invention is not in any way limited by this example.

A copyright owner may initially offer the digital item for, let us say, 20 money units. Users 1, 2, 3, . . . , n may post bids of varying amounts, such as 14.90, 14.75, 14.63, . . . 14.25. Each user has downloading and uploading BW. Table 1.1 shows the initial state. For simplistic purposes, the download and upload BW in this example are identical. Of course, in reality, they may differ as mentioned hereinabove.

The bidding users may compete to buy the item first, because the earlier they have the item, the more times they can sell it to the bidders who do not have it yet. The price may be determined in the competition process between the users. There might be no upper limit to the price. If the demand for the item is very high, and many users want it, the initial price may be very high. The owner may wait before he starts to sell, until a minimum number of users make their bids.

TABLE 1.1

| User | Bandwidth | Ask | Bid | No. of Sales | Balance | Royalties |
|---|---|---|---|---|---|---|
| Owner | 200 | 20 | — | — | — | — |
| User 1 | 400 | — | 14.90 | — | — | — |
| User 2 | 750 | — | 14.75 | — | — | — |
| User 3 | 300 | — | 14.63 | — | — | — |
| User 4 | 100 | — | 14.25 | — | — | — |

The copyright owner may sell the digital item to the highest bidder, in this example, user 1. To do so, he may lower his asked price to 14.90. After the transfer of the item is finished and the payment is done, the results are as can be seen in Table 1.2.

TABLE 1.2

| User | Bandwidth | Ask | Bid | No. of Sales | Balance | Royalties |
|---|---|---|---|---|---|---|
| Owner | 200 | 14.75 | | 1 | 14.90 | — |
| User 1 | 400 | 14.75 | — | — | −14.90 | — |
| User 2 | 750 | — | 14.75 | — | —- | — |
| User 3 | 300 | — | 14.63 | — | — | — |
| User 4 | 100 | — | 14.25 | — | — | — |

The copyright owner and buyer 1 are now both authorized to sell the Item and they both compete for selling the content to the next highest bidder, which is user 2. In our case, user 2 has a high BW and he can download from the owner and from user 1 together. The transfer is done at the total BW of 600 (200+400) and at the end, the price is divided between the owner and user 1 at a ratio of 200:400 (⅓ to the owner and ⅔ to user 1) as can be seen in Table 1.3.

TABLE 1.3

| User | Bandwidth | Ask | Bid | No. of Sales | Balance | Royalties |
|---|---|---|---|---|---|---|
| Owner | 200 | 14.63 | — | 1 + ⅓ | 14.90 + ⅓ * 14.75 + | +1.97 |
| | | | | | 1.97 = 21.78 | |
| User 1 | 400 | 14.63 | — | ⅔ | −14.90 + ⅔ * | −⅔ * 14.75 * |
| | | | | | 14.75*80% = −7.03 | 20% = −1.97 |
| User 2 | 750 | 14.63 | — | — | −14.75 | — |
| User 3 | 300 | — | 14.63 | — | — | — |
| User 4 | 100 | — | 14.25 | — | — | — |

Now three users have the item and offer it. All of them have free BW and want to sell to the next highest bidder, which is user 3. However, the total BW of the three is much more than what user 3 can use. Therefore, one of them will be chosen randomly, or according to a criterion like maximum BW, physical proximity, or minimum “ping” time. Lets assume that user 2 was selected to transfer to user 3 and that the transfer begins at a BW of 300, which is the maximum BW of user 3. Now all the offerers, including user 2 who still has the highest free BW (750−300=450), compete on the next bidder, which is user 4. Assuming user 2 wins again, he start to transfer to user 4 and continue to compete as he still has free BW of 350 (750−300−100=350).

In reality, there are many small delays and differences between the network peers. Therefore, usually only one user has free BW at a certain time. Even if a competition among offerers does occur, it ends very quickly and most of the time the offerers are supposed to be busy with fully utilized upload BW.

If, as we assumed, user 2 transfers the item to user 3 and to user 4, we have the results that are presented in Table 1.4.

TABLE 1.4

| User | Bandwidth | Ask | Bid | No. of Sales | Balance | Royalties |
|---|---|---|---|---|---|---|
| Owner | 200 | 14.15 | — | 1 + ⅓ | 21.78 + 5.78 = 27.56 | 1.97 + 5.78 = 7.75 |
| User 1 | 400 | 14.21 | — | ⅔ | −7.03 | −1.97 |
| User 2 | 750 | 14.11 | — | 2 | −14.75 + 14.63 + | −(14.63 + 14.25) |
| | | | | | 14.25 − 5.78 = 8.35 | *20% = −5.78 |
| User 3 | 300 | 14.11 | — | — | −14.63 | — |
| User 4 | 100 | 14.11 | — | — | −14.25 | — |

We can see in table 1.4 that the owner of the item has gained 27.56 from sales of the item and from royalties. User 1 has only one sale of part of the item and it is not covering the cost of the item so his balance is still negative. User 2 with his high BW has managed to finish two sales of the item and his balance is positive. Users 3 and 4 have not yet sold the item so their negative balance reflects only the payment for buying the item.

It is clear that the higher the BW, the more times the user will sale the item and the more income he will have. As a result, users with high BW can afford to pay more for the item, in order to get it sooner and sell it in a longer period of time.

Any user might be able to see information about the rating of the offerers and the requesters, as well as other information, such as but not limited to, information regarding if the item is copyrighted, who is the copyright owner and royalty information. Buyers may select sellers (and vise versa) based on this information or randomly or in any other manner.

It is noted that the system of the invention may be automated. For example, the user may order the system to maximize the return from the utilization of his computing resources, the system may automatically find for him the best item to buy, place a bid with the optimal price, make the transaction and immediately offer the bought item for sale until its price drops too much. At this point, the system can look for a new item and repeat the process from the beginning. Suitable algorithms may be implemented for automatic operation of the system. These algorithms can also be used to maximize BW and CP performance on computer networks, thereby preventing bottlenecks and maximizing the distribution speed of digital items. The system may optimally share and utilize available BW, CP, hard disk space and any other shareable resource of the network peers. The system may ensure that a peer who most needs the item (prepared to pay the highest price for it) will get first priority at downloading the item at maximum speed, from the peers who are the most currently available providers.

The system may also be used with virtual money. For example, instead of collecting revenues, an organization may use the system to investigate how peers contribute to the network resources or how they consume the network resources. Peers who accumulate positive balance, are contributing peers and peers who has negative balance, are consuming more than contributing to the network resources.

Another embodiment of the invention may include presenting names of items in the system before making the items themselves available. This may enable users who want the item to search, find and enter requests for the item in advance. The moment the item is available, the transfers may start immediately according to the request list.

In another embodiment of the invention, if a user wants an item, which cannot be found in the system, the user may enter a request for the item and may offer a price to another user who will make the item available. The methods and system of the invention may be considered symmetric: a user may choose to offer an item for sale or request an item to buy.

The system may have an automatic mode in which the system works to maximize the user profits from its items and peer resources. In this mode, the system may work unattended, downloading and uploading the items that may make the highest profit for the user. The calculations used by the system in automatic mode may be based on various factors, such as but not limited to, the upload and download BW, the behavior of the item price in time, money balance and limitations such as maximum price for new items that the user may fix in advance.

The system may work with or without a central server. If there is a central server, it may store and manage any pertinent information, such as but not limited to: A list of the users with their money balance, rating, line BW and other parameters; A list of the items, their length, royalties information and other parameters; A list of the licenses; A list of the bids; A list of the asks; And a list of the transfers that are currently taking place.

There may or may not be a minimum and/or maximum BW size for a single transfer.

Users may deposit money into their account in the system from their credit card, from their bank account, from their telephone bill and/or from any other billing system that the user prefers. There may be a minimum and/or maximum amount of money for a single deposit. Users may also withdraw money from their account in the system, to the same sources mentioned and with similar limitations. There may also be a special percentage charged for each withdrawal and/or deposit, which may go to the system operators.

Users may transfer money between their personal accounts in the system. In this way, users may also donate money from their accounts to charity and other organizations that may be invited to become users in the system.

Reference is now made to Table 2.1, which illustrates a method for searching in accordance with a preferred embodiment of the present invention, and which may be used for searching for items in the method for content exchange described hereinabove. This method of searching can also be used in other searching systems and in general, it can be used in any system where a combination of words and/or manipulations of KW can help.

In order to facilitate a user searching for an item, the system may display KWs (keywords) for the user to select. Each KW is linked to one or more items, and every item may have KWs attached thereto. KWs may be typed manually or may be selected from lists. For example, in Table 2.1, a first list of KWs is displayed. Next to each KW, an amount of items that would be found if that KW were selected, may be displayed. For example, if the word “Song” were selected, 1765 items would be found. The list of KWs might be sorted according to the number of items to be found.

TABLE 2.1

| KW1 | Found Items |
|---|---|
| The | 2755 |
| Big | 2140 |
| Of | 1807 |
| Song | 1765 |
| Movie | 952 |

After selecting a KW from the first list, the user may then combine that KW in any Boolean expression (e.g., AND, OR, NOT, etc.) with a second KW from a second list of KWs. For example, table 2.2 shows what we may see if “Song” AND “Michael” were selected. 987 items were found for this combination of KWs. If we select “MP3” instead of “Michael”, only 158 items would be found. In addition, if we select “Movie” instead of “Song”, only 221 items would be found.

TABLE 2.1

| KW1 | Found Items | KW2 | Found Items |
|---|---|---|---|
| The | 893 | Foot | 358 |
| Big | 414 | Hand | 461 |
| Of | 750 | Michael | 987 |
| Song | 987 | MP3 | 158 |
| Movie | 221 | 128 | 711 |

Additional KWs may be selected in a similar recursive way from further lists. Previously selected KWs may be unselected, modified or replaced by other KWs from the same list or from other lists of KWs. Typing one or more first letters of a KW may cause the system to display all KWs that start with those letters.

In accordance with another embodiment of the invention, a “meta-KW” may be implemented. For example, a meta-KW may be a general topic, e.g., “singers” and the list of KWs would then be names of singers. A user may be able to choose from a predetermined, or automatically created, list of meta-KWs, and be provided with a list of KWs associated with that meta-KW. Any list of KW can be linked to any meta-KW.

In accordance with another embodiment of the invention, the search may include the ability to select numeric KWs. For example, the user may be able to choose all items with a price above 45 money units, or in a range of prices like 5-45.

In addition to the amount of items to be selected, some other parameters may be stored or presented next to each KW in any of the KWs lists. For example: how many users also chose the particular KW, possibly indicating popularity of the item, or what is the highest price of the items to be found with the selection of the KW. The user may be able to sort the list of available KWs according to these parameters and according to various other parameters.

The method of searching of the invention may significantly facilitate the art of searching. The user does not need to recall or invent KWs; he may easily select a KW from a list of relevant KWs, provided by the system. The user quickly “homes in” on the desired end-result by seeing how many entries and other possible parameters match the selected combination of KWs. From the system point of view, all the KWs lists are automatically prepared and automatically updated after each change in the selected KWs. Be it a replacement or deletion of KW in the existing KWs lists, or selection of an additional KW from a new KW list.

It will be appreciated by person skilled in the art that the present invention is not limited by what has been particularly shown and described herein above. Rather the scope of the present invention is defined only by the claims that follow:

What is claimed is:

1. A method for exchange of items, the method comprising:
auctioning a digital item for sale from an offerer of said digital item who is authorized to sell said digital item; and
selling said digital item by uploading to a requester who, upon purchasing and downloading said digital item, is authorized to become another offerer of said digital item, wherein a capability of said offerers to transfer and sell said digital item to further requesters is a function of at least one of a download capability and an upload capability of said offerers.

2. The method according to claim 1, wherein a sale of said digital item by one of said offerers is transactable only if a condition is met, said condition comprising at least one of:
said offerer has a minimum upload communication bandwidth;
said requester has a minimum download communication bandwidth;
a minimum bid price;
a minimum number of requesters;
a minimum number of offerers; and
a minimum level of rating of the offerer and the requester, wherein said level of rating is a function of a behavior of a user with other users.

3. The method according to claim 1, further comprising:
automatically finding the best price for said item;
transferring said item from the offerer to the requester; and
transferring money for said item between the requester and the offerer.

4. The method according to claim 1, further comprising:
paying a royalty to a copyright owner of said digital item upon selling said digital item, wherein said royalty value comprises at least one of:
a percentage of the price of the item, not below a certain minimum and not above a certain maximum;
a fixed value;
a value dependent on the users characteristics; and
a value dependent on the item characteristics.

5. The method according to claim 1, further comprising presenting names of digital items before making said items available for transfer between users and entering a request in advance for a digital item and transferring said item when said item becomes available.

6. The method according to claim 1, further comprising entering a request in advance for a digital item and offering a price to another user who makes said item available.

7. The method according to claim 1, further comprising automatically downloading and uploading digital items in accordance with criteria that improve profits of a user.

8. The method according to claim 1, further comprising providing user accounts for transfer of money from one account to another account.

9. The method according to claim 1, further comprising permitting a user to choose between auctioning an item for sale and reverse auctioning an item to buy.

10. The method according to claim 1, wherein selling said digital item comprises:
dividing users with a minimum amount of free bandwidth into a list of requesters (L1) and a list of offerers (L2);
selecting a pair of users comprising a requester from L1 and an offerer from L2 in accordance with a selection criterion; and
transferring a digital item between the selected requester and the selected offerer.

11. The method according to claim 10, wherein said selection criterion comprises at least one of an availability of bandwidth, a bid price, and an ask price.

12. The method according to claim 10, further comprising sorting said lists L1 and L2 in accordance with a sorting criterion and selecting the said pair as the two first users from the sorted L1 and L2.

13. The method according to claim 12, wherein said sorting criterion comprises at least one of a request price, an offer price, time of requesting, time of offering, and proximity of the users in a plurality of the pairs.

14. The method according to claim 1, further comprising searching for said digital item prior to requesting or offering said digital item, wherein said searching comprises:
displaying a plurality of lists of keywords and an amount of items that would be found if a keyword from one of said lists were combined with the selected keyword from another of said lists.

15. The method according to claim 14 wherein said keywords are combinable in a Boolean expression.

16. A method for searching comprising:
providing searchable items, keywords, a list of keywords (hereinafter: LKW), each item connected to at least one keyword;
displaying one or more LKWs, wherein each keyword in every LKW can be selected or unselected, and
displaying, next to each keyword in every LKW, the number-of-items-that-would-be-found if this keyword were selected,
wherein there is a first group of Boolean operators between groups of items selected by keywords from the same LKW and wherein there is a second group of Boolean operators between groups of items selected by keywords from different LKW.

17. The method according to claim 16, wherein all the Boolean operators in the first group are an “or” and all the Boolean operators in the second group are an “and”.

18. The method according to claim 16, wherein in addition to the number-of-items-that-would-be-found, further displaying at least one of how many times a particular keyword was selected by others, the number of items to which the particular keyword is connected, the rating of the particular keyword, the maximum/minimum/average price of the items that would be found if the particular keyword were selected, stored information pertaining to the particular keyword, and stored information pertaining to items that would be found if the particular keyword were selected.

19. The method according to claim 16, wherein if there is a selected keyword in every LKW, a new LKW is created with no selected keywords, and if there are two or more LKWs with no selected keyword, one of them remains and the rest are removed.

20. The method according to claim 16, further comprising not displaying keywords, which if selected in combination with other selected keywords results in zero selected items.

21. The method according to claim 16, further comprising defining a meta-keyword as a keyword related to other keywords, and using the meta-keyword to limit the keywords in a LKW to one kind of keywords.

22. A system for the exchange of digital items, comprising:
a network of computers, each computer having at least one of upload bandwidth capacity and download bandwidth capacity, said computers being able to exchange items among said computers,
and a management system that manages personal accounts for the computers and for its users;
wherein said computers are able to be offerers and generate offers to send items,
wherein said computers are able to be requesters and generate requests to receive items,
wherein said computers are able to accept offers of other computers,
wherein said computers are able to accept requests of other computers,
wherein said computers are able to search, find, arrange, sort and display information about the items, the offers, the requests, the computers, the bandwidth and the users,
wherein for at least a portion of the items there are items, that when they are transferred from an offerer to a requester, a copy of said items stays with the offerer,
wherein an offer of an item by an offerer cannot be accepted if that offerer does not have enough free bandwidth to send that item,
wherein a request of an item by a requester cannot be accepted if that requester does not have enough free bandwidth to receive that item, and
wherein payments for the items, royalties to copyright owners of the items and commissions to operators of the system are payable through said personal accounts.

23. The system according to claim 22, wherein said computers are further able to:
enter item details into the system without entering the item itself into the system;
to find said details in the system, when performing a search for items;
to add the item into the system later and establish a connection between the item and its details that have been entered in the system; and
to place requests for the item even when the item itself is not present in the system.

24. The system according to claim 22, wherein said computers are further able to:
to divide large items into smaller parts, wherein each of said smaller parts is transferable separately and independently, wherein each of said smaller parts has its own license, and wherein the parts are identified as parts of a larger item.
